(19) United States
(12) Patent Application Publication
(10) Pub. No.: US 2009/0171702 A1
(43) Pub. Date: Jul. 2, 2009

(54) SYSTEM AND METHOD FOR MAINTENANCE OF RESIDENCES

(75) Inventors: Jerry Foster, JR., Odessa, FL (US); Susan J. Foster, Odessa, FL (US); Timothy S. Glisson, Tampa, FL (US)

Correspondence Address: LARSON AND LARSON, 11199 69TH STREET NORTH, LARGO, FL, 33773, US

(73) Assignee: FOSTERGLISSON, INCORPORATED, Odessa, FL (US)

(21) Appl. No.: 11/965,268

(22) Filed: Dec. 27, 2007

(51) Int. Cl. G06Q 10/00; G06F 17/40

(52) U.S. Cl. 705/7

(57) ABSTRACT

An application for a computer-based method for managing a property includes providing a server computer system and a client computer system. A list of maintainable inventory items is accepted at the client computer system and sent from the client computer system to the server computer system where the list of the maintainable inventory items is processed. The processing includes generating maintenance tasks relating to the list of the maintainable inventory items based upon a set of maintenance procedures. The maintenance tasks are then tracked at the server computer system.

### FIELD OF THE INVENTION

This invention relates to the field of residential maintenance and more particularly to a system for managing and scheduling residential inventory and maintenance tasks.

### BACKGROUND OF THE INVENTION

Every home owner knows that along with owning a home, they must maintain various household products such as the furnace, air conditioner, air cleaner, pool, spa, lawn mower, sprinkler system, etc. Many such products require tools to maintain such as wrenches, screwdrivers, etc. In addition, many such products require cleaning or the replacement of expendable parts based upon use or time-in-service, for example filters, sanitizing chemicals, etc. When faced with performing so many different tasks at different intervals, the homeowner has difficulty remembering when some tasks must be performed and how to do them. Additionally, the homeowner often finds they are ready to perform a task but they don't have the required tools or expendable parts.

It is possible for a homeowner to create a task list or schedule of such tasks by reading and understanding user manuals for each item or inventory in their home. For example, the homeowner could read the user manual for their home air conditioner and determine that the filters need be changed every six months; that the air conditioner unit needs to be checked every year for proper operation and coolant pressure; and that the outside air exchanger needs cleaning every spring. This process requires the homeowner to have and read user manuals for each piece of inventory in or around their home such as pools, spas, air filters, lawn mowers, cars, etc. It would be easier for the homeowner to provide a simple list of such inventory to a system such as that of the present invention and the system would find information regarding tasks that need be performed and create an active task list that is, possibly, updated as the manufacturer changes their maintenance procedures, etc.

U.S. Pat. Publication No. 2007/0027735 to Rokos describes a method and apparatus for managing a plurality of geographically dispersed properties. This publication does not create a task list given a list of inventory items for use by a homeowner to perform the tasks of maintaining their home.

U.S. Pat. Publication No. 2006/0155815 to Labedz, et al, describes a system for managing maintenance of buildings. In it, the user creates the tasks rather than describing the inventory of the residence and having the tasks automatically generated.

U.S. Pat. Publication No. 2006/0064305 to Alonso describes a system for reporting and managing security and maintenance issues for a building. In it, issues such as a light being out are entered, assigned and closed. This application does not generate tasks based upon building/home inventory.

U.S. Pat. Publication No. 2005/0222889 to Lai, et al, describes a system for assimilating inspection data and generating repair tasks for a building. In it, inspection data (e.g., text, photos) are provided and work orders created and assigned to contractors, etc. This application does not disclose generation of work tasks based upon a building/home inventory.

U.S. Pat. Publication No. 2005/0144028 to Donahue, et al, describes a system for property management, in particular, management of complaints by the tenants. Although this application includes a module to schedule preventative maintenance, it requires that the owner populate a maintenance activity database. This application does not automatically generate such an activity database based upon a building's inventory.

U.S. Pat. No. 6,745,200 to Starkey describes a system for defining, scheduling and executing tasks performed by service staff. It does not define or schedule maintenance tasks to be performed by the property owner (or surrogate) based upon an inventory of the premise/building.

What is needed is a system that will automatically generate maintenance tasks for a building based upon the inventory of the building.

### SUMMARY OF THE INVENTION

It is one objective of the present invention to provide an automatic task generation and tracking system where as the tasks are generated from a home/building inventory.

It is another objective of the present invention to automatically update the tasks when a manufacturer changes their maintenance specifications or user manuals.

It is another objective of the present invention to track expendable supplies related to the performance of the tasks.

It is another objective of the present invention to reorder expendable supplies as supplies deplete in response to completion of the generated tasks.

In one embodiment, a method for managing a property is disclosed including providing an inventory list of maintainable items associated with a property and a set of maintenance procedures. For each of the maintainable items in the inventory list, the set of maintenance procedures is used to generate at least one maintenance task and the maintenance tasks are tracked.

In another embodiment, a computer-based method for managing a property is disclosed including providing a server computer system and a client computer system. A list of maintainable inventory items is accepted at the client computer system and sent from the client computer system to the server computer system where the list of the maintainable inventory items is processed. The processing includes generating maintenance tasks relating to the list of the maintainable inventory items based upon a set of maintenance procedures. The maintenance tasks are then tracked at the server computer system.

In another embodiment, a system for managing a property is disclosed including a server computer system adapted to receive a list of maintainable items and having a set of maintenance procedures. The server computer system uses the list of the maintainable items and the set of the maintenance procedures to generate a set of maintenance tasks. A client computer system having a unique identity accepts the list of the maintainable items from a user and send the list of the maintainable items to the server computer system where the list of the maintainable items, the set of the maintenance procedures and the set of the maintenance tasks are stored in a database.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of the present invention.

FIG. 2 illustrates a schematic view of the relationship of data of the present invention.

FIG. 3 illustrates a flow chart of automatic task generation the present invention.

FIG. 4 illustrates a flow chart of manual task generation the present invention.

FIG. 5 illustrates a flow chart of performing tasks using the present invention.

FIG. 6 illustrates a user interface for creating a user account according to the present invention.

FIG. 7 illustrates a user interface for creating/editing an inventory according to the present invention.

FIG. 8 illustrates a user interface for determining what tasks need be done according to the present invention.

FIG. 9 illustrates a user interface for uploading and downloading backup files according to the present invention.

FIG. 10 illustrates a user interface for notification and disposition of automatic supplier updates according to the present invention.

FIG. 11 illustrates a user interface for automatically ordering expendable parts according to the present invention.

FIG. 12 illustrates a user interface for reviewing a supplier order status according to the present invention.

FIG. 13 illustrates a schematic diagram of data and task interaction according to the present invention.

FIG. 14 illustrates an exemplary computer system as used by the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

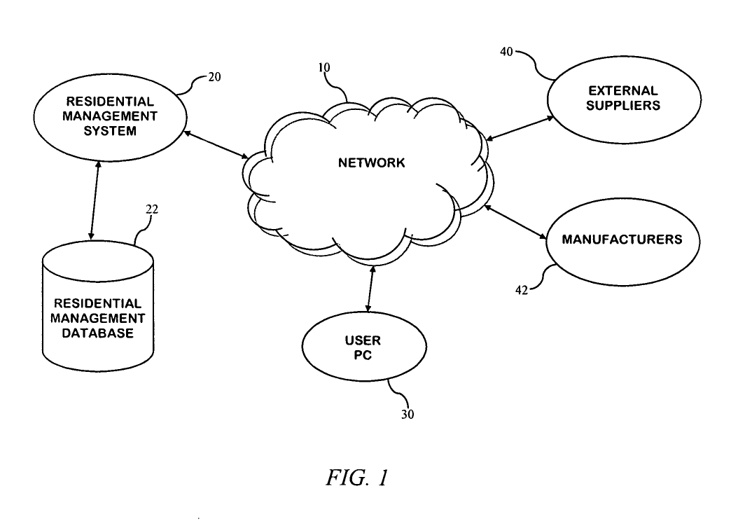

Referring to FIG. 1, a schematic view of a system of the present invention is shown. The residential management system 20 is a server-based application that interfaces with customers and suppliers through a network such as the Internet 10. Customer computer systems 30 access the residential management system 20 through a network such as the Internet 10. Each customer has an account (unique identifier) and associated account data, a maintainable inventory list, a maintenance task list, a tools list, an expendable materials list, data files, etc., which are stored in a residential management database 22 that interfaces with the residential management system 20. The customers access the residential management system 20 through a personal computer 30 or other Internet connected device such as a Blackberry®, cell phone, Portable Data Assistant, etc., to enter/update list items, review tasks, notify the residential management system 20 of completed tasks, generate purchase orders, place orders, etc.

The residential management system 20 interfaces in some embodiments to external suppliers 40 and manufacturers 42 as known in the industry, one such way is through the Internet 10. In some embodiments, the residential management system 20 interfaces to external suppliers 40 to place orders for expendables such as filters, chlorine, etc. In some embodiments, the residential management system 20 interfaces to manufacturers 42 to obtain maintenance instructions, updates, specifications, user manuals, etc.

In some embodiments, a customer account relates to one entity such as a home, apartment, townhouse, etc. In some embodiment, the customer is a property manager and the customer account relates to a group of entities such as apartments in an apartment building. In some embodiments, the residential management system 20 tracks other entities such as automobiles, trucks, etc.

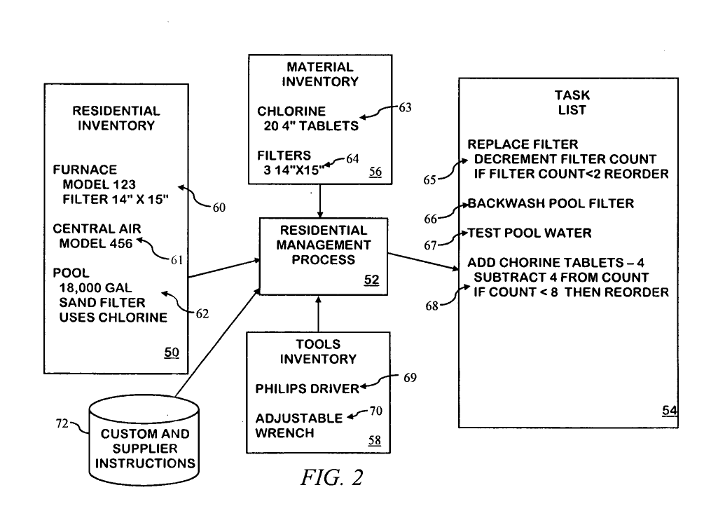

Referring to FIG. 2, a schematic view of the relationship of data of the present invention is shown. In general, the residential management process 52 reads the residence inventory 50 to determine what tasks need be completed, when, and what tools and inventory are needed. In the example shown in FIG. 2, a simple residential inventory 50 includes a furnace 60 that uses a 14″ by 15″ filter; a central air conditioner 61 and a pool 62 that has a sand filter and uses chlorine as a sanitizer. The residential management process 52 initially reads the inventory 50 to determine what tasks need be completed, thereby establishing a schedule The residential management process 52 consults the supplier and custom instructions 72 to determine the frequency of the tasks, the instructions for completing the tasks, the materials needed to perform the tasks and the tools needed to perform the task. The residential management process 52 consults a material inventory 56 to determine if the required materials are available to complete the tasks. In this example, the material inventory includes 20 4″ chlorine tablets 63 and three (3) 14″ by 15″ furnace filters 64. The residential management process 52 generates a list of tasks 54 to be completed at specific times. In this example, the task list includes replacing the furnace filter 65. Note that this task 65 (or instruction) includes an instruction to subtract the filter from the inventory and, if the inventory goes below two, reorder the filters. The task list also includes testing the pool water 67 and adding 4 chlorine tablets 68. Note also that the task 68 includes subtracting 4 from the inventory count and, if the inventory count for chlorine tablets goes below 8, reordering chlorine tablets.

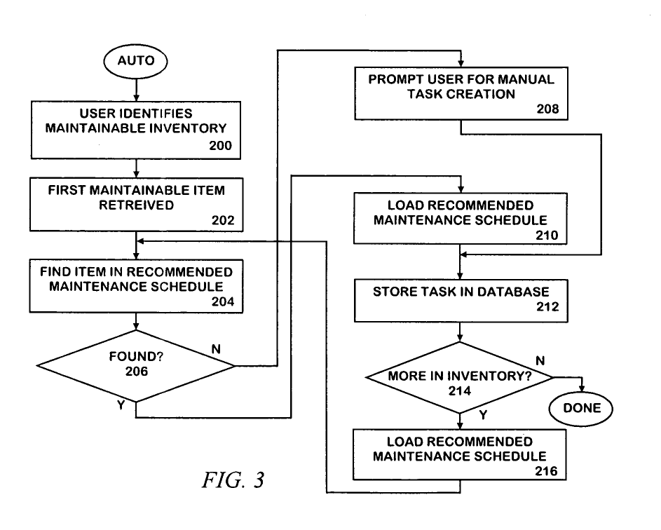

Referring to FIG. 3, a flow chart of automatic task generation the present invention is shown. After the user's account is created, the user identifies their maintainable inventory 200. This is done by entering the make, model number, features, etc. of each maintainable device in their home. In some embodiments, a wizard as known in the industry is used to lead the user through the inventory creation.

Next, the residential management process 5 retrieves the first maintainable item 202 and looks in the supplier/custom instructions 72 to see if this inventory item is known 204 and there are instructions, etc., relating to this inventory item. If it is not found 206, the user is prompted for manual task creation 208 which includes, for example, entering the time period between maintenance operations, the tools required and the expendable parts required, etc. Once all of this is entered, the task is stored in the task database 212.

If the inventory item is known 206, the recommended maintenance schedule (including expendable parts and tools) is loaded 210 and then stored in the task database 212.

Next, if more inventories remain 214, the next inventory item is retrieved 216 and the above steps repeated. If no more inventories remain 214, the process completes.

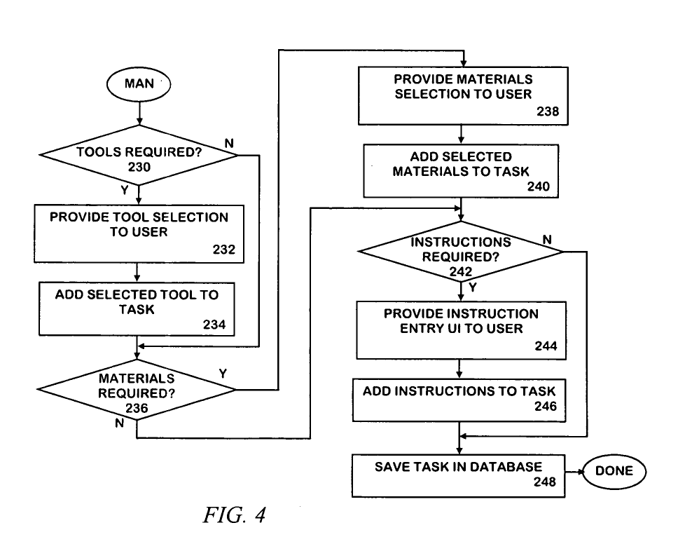

Referring to FIG. 4, a flow chart of manual task generation the present invention is shown. When an inventory item is added that is not known to the residential management process 52, the user must manually enter information and instructions regarding that item. As an example, the residential management process 52 first asks if any tools are required 230. If so, the user is provided a selection of tools from which to pick such as hammer, Philips screw driver, wrench, etc. The user selects the tool(s) needed and they are added to the task 234. Furthering the example, the residential management process 52 asks if any materials are required 236. If so, the user is provided a selection of materials 238 from which to pick such as fertilizer, filters, chlorine, etc. The user selects which materials are needed and they are added to the task 240. Furthering the example, the residential management process 52 asks if any maintenance instructions are required 242. If so, the user is presented a user interface to enter the instructions 244 and the instructions are added to the task 246. Once all data is collected, the task is stored in the database 248. There are many ways known in the industry to collect such information and all are included herewithin. In some cases, a particular tool or material is not previously known to the residential management process 52 and will not appear in the selection list. In such a case, the user must enter information regarding the tool/material such as name, details, supplier details, reorder information and costs, etc.

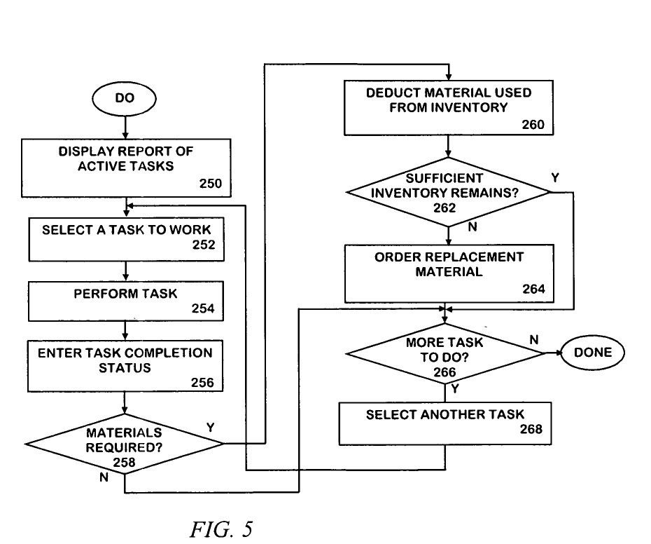

Referring to FIG. 5, a flow chart of performing tasks using the present invention is shown. To determine what tasks are due, the user requests a display of active tasks 250. In some embodiments, the user selects a time frame such as one week, a date range, etc. Next, the user selects a task to perform 252 (e.g., change the furnace filter). The user performs the task 254 and when done, marks the task as being complete 256. If materials were required to perform the task 258, the quantity of each material is deducted from the inventory 260 to maintain a proper inventory. If there is not sufficient inventory remaining 262 (e.g., less than a pre-determined threshold), replacement materials are ordered 264. If there are no more tasks to perform 266, the process is complete. If there are more tasks to perform 266, the next task is selected 268 and the previous steps are repeated on that task.

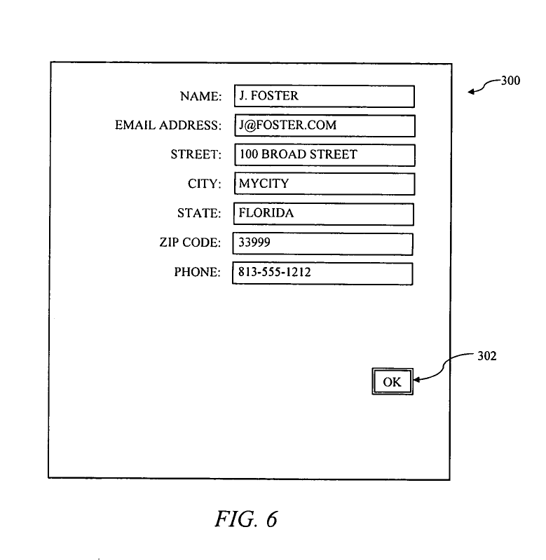

Referring to FIG. 6, a user interface for creating a user account according to the present invention is shown. In this exemplary user interface 300, the user creates an account with their name, email address, home address and phone number. In some embodiments, the email address becomes the user's account number while in others; an account number is assigned, etc. In other embodiments, other information is gathered regarding the user as known in the industry.

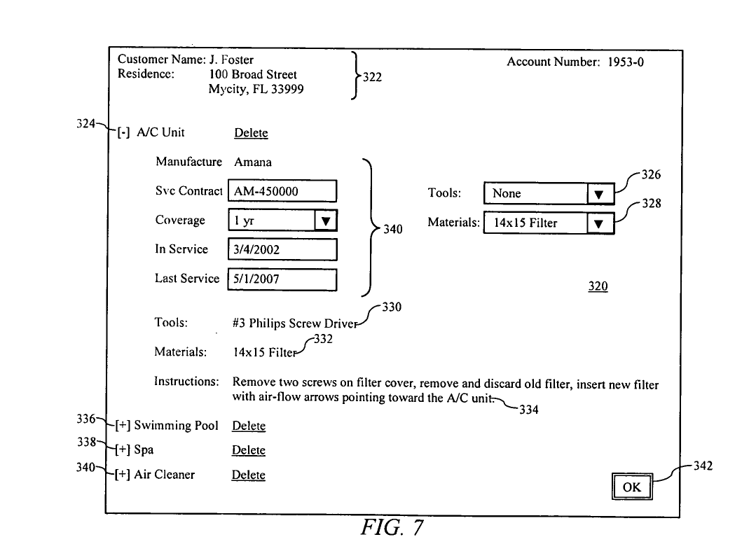

Referring to FIG. 7, a user interface for creating/editing an inventory according to the present invention is shown. In this exemplary user interface 320, customer information appears at the top 322 such as name and address and account number. Although there are many ways known in the industry to display a list of inventory along with relevant information, this example shows each inventory item with an expand/contract icon 324/336/338/340. Selecting the contract icon 324 reduced the item to a summary line and selecting the expand icon 336/338/340 expands the item to show details. The icons 324/336/338/340 flip-flop to reverse their operation after being selected.

In this example, four items are in the inventory, an A/C unit, swimming pool, spa and air cleaner. Hot keys are provided to allow for deletion, though other hot keys are provided in other embodiments for other purposes such as allowing editing, etc. The item's details are shown 340 for example, as whether there is a service contract, the coverage term, the data it was put into service and the last date it was serviced. A list of tools required to perform periodic maintenance is listed 330 and the expendable materials used during the periodic maintenance is also listed 332. Periodic maintenance instructions are also shown 334. To finish with this display, the user selects the “OK” icon 342.

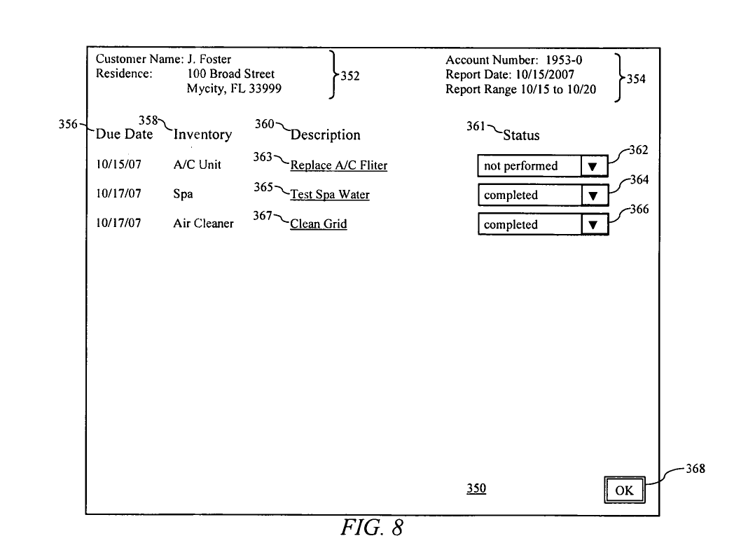

Referring to FIG. 8, a user interface for determining what tasks need be done according to the present invention is shown. This exemplary task list 350 includes information such as name and address 352; and account number 354, report dates and report date ranges at the top of the report 350. Although there are many ways known in the industry to display a list of tasks to be completed, this report includes a table with a set of columns, each having a task due date 356, a short inventory description 358, a task description 360 and a status 461. For each task, a row includes the date (e.g., Oct. 15, 2007), the inventory item name (e.g., A/C Unit), a description of the task (e.g., replace A/C filter) and a disposition 362/364/366. In this example, the disposition field is a pull-down list, though many other user interface paradigms are possible, all of which are included here within. In this example, the first task has not been performed 362 and the second and third has been completed 364/366. Other status are possible such as, “defer,” “ignore,” and “waiting; where waiting indicates that the homeowner is waiting for parts, etc. After completing the tasks and/or updating the associated status, the user selects the “OK” icon 368 to proceed.

In some embodiments, the task descriptions 363/365/367 are hot links. By selecting one of the hot links 363/365/367, detailed instructions for performing the task are displayed such as “remove two screws from filter cover; open filter cover; remove old filter; place new filter with arrows facing down; close cover; replace two screws.”

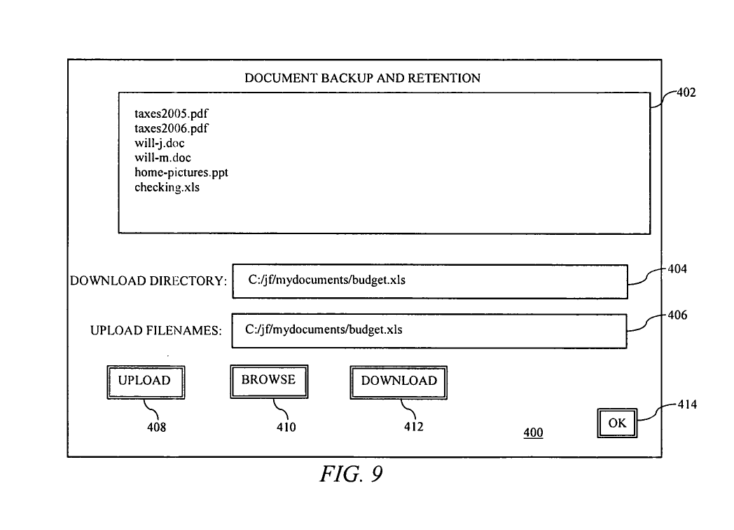

Referring to FIG. 9, a user interface for uploading and downloading backup files according to the present invention is shown. In this exemplary user interface 400, the user is provided tools to upload and/or download files to and from their computer system. This capability provides a simple, quick backup and restore for the homeowner, etc. A list of currently backed-up files 402 is provided. In some embodiments, the date/time of backup and/or the source directory is provided. In some embodiments, this information is displayed by clicking the file name or by moving the mouse over the file name or other ways as known in the industry. There are many ways known to upload/download files to/from a web server, all of which are included here within. In this example, the user enters a download directory name 404, selects the files to download from the list 402 and selects the “Download” icon 412 to complete the download to their computing device. In some embodiments, the user is prompted to replace the file if it already exists, as known in the industry.

Also, in this example, to upload one or more files, the user enters the filenames in the upload filenames field 406 and selects the “Upload” icon 408 to complete the upload. In some embodiments, browse function is provided by selecting the “Browse” icon 410 then following a navigation screen to find files to upload or download as known in the industry.

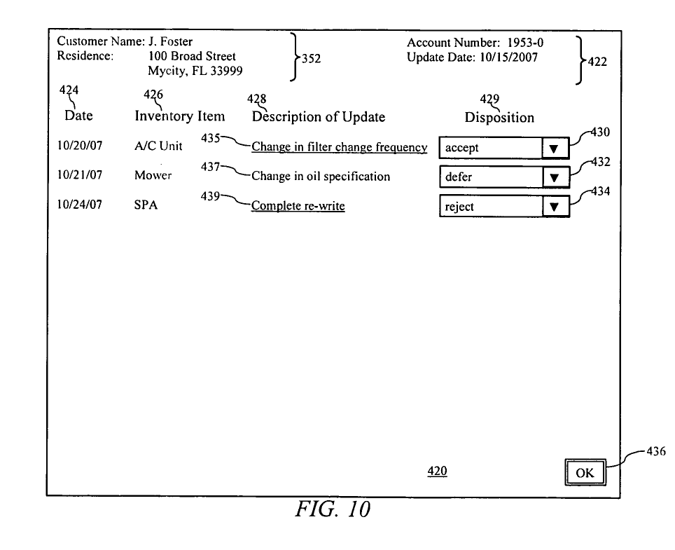

Referring to FIG. 10, a user interface for notification and disposition of automatic supplier updates according to the present invention is shown. The system of the present invention utilizes various types of maintenance procedures to create the tasks and instruct the homeowner (property manager) to perform the maintenance tasks. Some procedures are created by the homeowner. Some procedures are created by an administrator of the residential management process 52 while other procedures come directly from the manufacturers. In this exemplary update user interface 420, user information 352 and account and date information 422 is provided.

Although there are many ways known in the industry to depict changes, this exemplary change user interface 420 has a table with columns for the date of the change or new procedure 424, a brief title of the inventory item affected 426, a description of the update 428 and a disposition selection 429. The disposition selection 429 provides the user with a tool to accept, reject or defer the updated procedure. For example, the user has marked the procedure that updates the filter change frequency 435 to “accept” 430, the procedure that changes the oil specification 437 to “defer” 432 and has marked the complete re-write of the spa procedure 439 to “reject” 434. In some embodiments, the description 435/437/439 is a hot link and, selecting the hot link shows the user details regarding the change. As an example, the change in filter frequency 435 has a change from once every twelve months to once every 14 months, the change in oil specification 437 has a change from 10W40 to 10W50 and the spa re-write 439 has a totally new procedure for maintaining the spa. Once the user accepts/rejects/defers the update, the user selects the “OK” icon 436 to proceed. In other embodiments, more or less dispositions are anticipated.

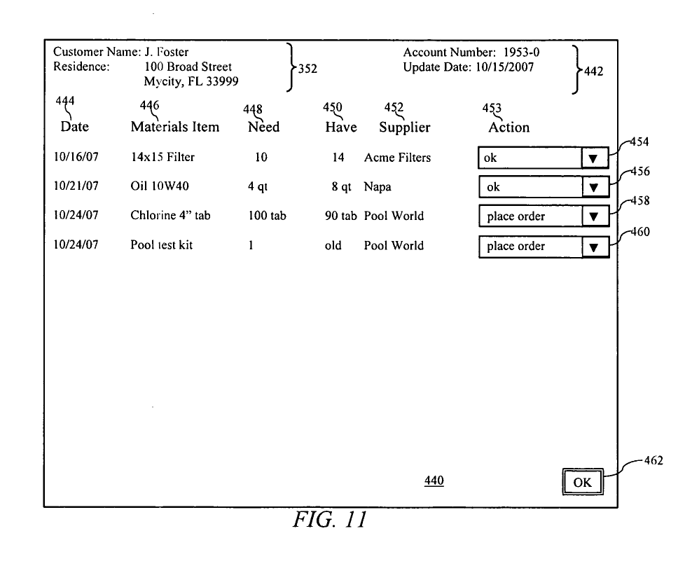

Referring to FIG. 11, a user interface for automatically ordering expendable parts according to the present invention is shown. In some embodiments of the present invention, the inventory of expendable parts such as filters, oil and chlorine is tracked as tasks are completed and the expendables are used. In some embodiments of the present invention, one or more of the materials (expendables) has an associated threshold or other way of determining that the inventory of materials (expendables) is low. This exemplary expendables user interface includes information such as name and address 352; and account number and update date 442 at the top of the report 350. Although there are many ways known in the industry to display a list of expendables, this exemplary report includes a table with a set of columns, each having a date 444, description of the material 446, quantity needed 448, quantity on hand 450, supplier name 452 and action 453. In some embodiments, the date 444 is the date that the material was last used, etc. In the example shown, there are 14 14″ by 15″ filters in stock and 10 are needed, so there are plenty of filters; hence, the “Action” field 453 is “Ok” 454. Similarly, 4 quarts of oil is needed and 8 quarts are in stock and the “Action” field 453 is “OK” 456. There are only 90 chlorine tablets, whereas it is shown that 100 should be in inventory; hence the “Action” field 453 is “place order” 458. The last row shows a pool test kit of which one is needed. Although a pool test kit is already in stock, it is marked as old in the “Quantity” 450 column and therefore needs to be ordered 460.

There are many possible dispositions such as, “defer” (wait until later to make an order), “on order” (a previous order was made but not received), “received” (show an order was received), etc. Once the disposition fields 453 are set properly, the user selects the “OK” icon 462 to proceed. At this time, those rows that have dispositions that indicate action are processed. For example, in some embodiments, the rows that include “place order” 456/460 automatically generate an electronic order for chlorine and a test kit to pool world. In alternate embodiments, an order is printed for the user to take to get it filled. In some embodiments, a simple “to-do” list is created to remind the user what they need to get. As before, many different user interface paradigms are possible, all of which are included here within.

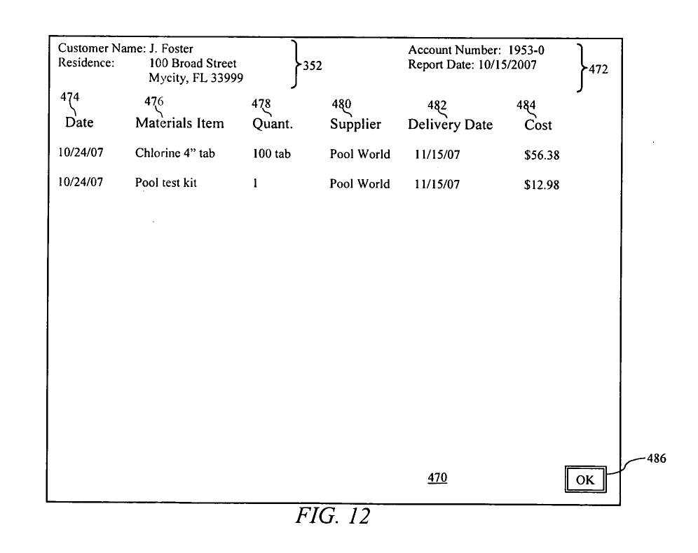

Referring to FIG. 12, a user interface for reviewing a supplier order status according to the present invention is shown. This exemplary outstanding purchases user interface includes information such as name and address 352; and account number and report date 472 at the top of the report 370. Although there are many ways known in the industry to display a list of outstanding purchases, this exemplary report includes a table with a set of columns, each having a date ordered 474, description of the material 476, quantity ordered 478, supplier name 480, expected delivery date 482 and total cost 484. Other details are envisioned, such as unit price, supplier address, links to material manufacture, etc.; all ow which are included here within. When finished reviewing the materials on order user interface, the user selects the “OK” icon 486 to proceed.

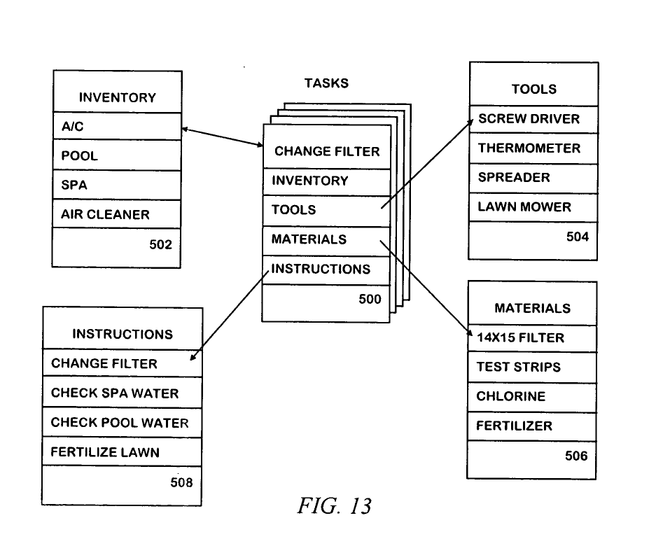

Referring to FIG. 13, a schematic diagram of data and task interaction according to the present invention is shown. Although many data arrangements are possible to implement the present invention, the example of FIG. 13 shows an inventory 502 that includes various items such as an air conditioner, pool, spa and air cleaner. Note that the list is simplified to show the relationships. In a typical implementation, each inventory record includes more information regarding each inventory item such as manufacturer, model, date put into service, features, etc. A task list 500 is generated based upon the inventory. In this example, a task is created to change the filter. Another task is, for example, perform yearly maintenance. Each task 500 refers back to the inventory item 502 and to an entry in the instructions database 508, the tools database 504 (if needed) and the materials database 506 (if needed). In this example, the tools entry in the task 500 refers to a screw driver in the tools database 504, the materials entry in the task 500 refers to a filter in the materials database 506 and the instructions entry in the task 500 refers to the change filter instructions in the instructions database 508. More or less relationships are envisioned as needed by specific tasks, all of which are included here within.

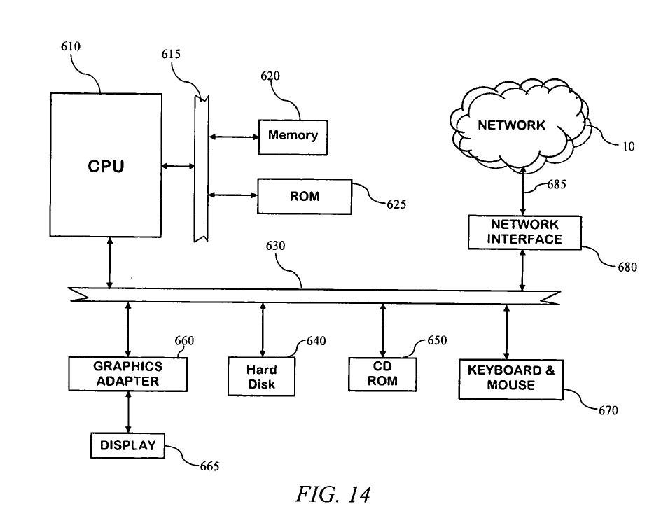

Referring to FIG. 14, a schematic diagram of a computer system of all embodiments of the present invention will be described. Although shown in its simplest form, having a single processor, many different computer architectures are known that accomplish similar results in a similar fashion and the present invention is not limited in any way to any particular computer system. The present invention works well utilizing a single processor system as shown in FIG. 14, a multiple processor system where multiple processors share resources such as memory and storage, a multiple server system where several independent servers operate in parallel (perhaps having shared access to the data or any combination. In the example shown, a processor 610 is provided to execute stored programs that are generally stored for execution within a memory 620. The processor 610 can be any processor or a group of processors, for example an Intel Pentium-4® CPU or the like. The memory 620 is connected to the processor through a memory bus 615. The memory 620 is any memory suitable for connection with the selected processor 610, such as SRAM, DRAM, SDRAM, RDRAM, DDR, DDR-2, etc. Firmware is stored in firmware storage 625 that is connected to the processor 610, also through the memory bus 615 and may include initialization software known as BIOS.

Also connected to the processor 610 is a system bus 630 for connecting to peripheral subsystems such as a network interface 680, a hard disk 640, a CDROM 650, a graphics adapter 660 and a keyboard/mouse 670. The graphics adapter 660 receives commands and display information from the system bus 630 and generates a display image that is displayed on the display 665.

In general, the hard disk 640 may be used to store programs, executable code and data persistently, while the CDROM 650 may be used to load said programs, executable code and data from removable media onto the hard disk 640. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 630 or with other input-output connections. Examples of these devices include printers; graphics tablets; joysticks; and communications adapters such as modems and Ethernet adapters.

The network interface 680 connects the computer-based system to the world-wide-web 10 through a link 685 which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for managing a property, the method comprising:
providing an inventory list of maintainable items associated with a property;
providing a set of maintenance procedures;
for each of the maintainable items in the inventory list, using the set of maintenance procedures to generate at least one maintenance task; and
tracking the maintenance tasks in a computer system.

2. The method for managing a property of claim 1, at least one of the maintenance procedures is provided by a manufacture of at least one of the maintainable items.

3. The method for managing a property of claim 1, further comprising:
tracking an inventory of expendable items, the expendable items related to the maintenance tasks.

4. The method for managing a property of claim 1, further comprising:
tracking an inventory of reusable tools, the reusable tools used to perform at lest one maintenance task of the maintenance tasks.

5. The method for managing a property of claim 3, further comprising:
when tracking the inventory of expendable items, if a quantity of one of the expendable items falls below a predetermined amount, generating an order for replacement of the one of the expendable items.

6. The method for managing a property of claim 5, further comprising automatically sending the order to a supplier.

7. The method for managing a property of claim 1, wherein the step of tracking includes generating a report of the maintenance tasks that are ready to be performed.

8. The method for managing a property of claim 1, further comprising accepting and storing data files.

9. A computer-based method for managing a property comprising:
providing a server computer system;
providing a client computer system;
accepting a list of maintainable inventory items at the client computer system;
sending the list of the maintainable inventory items from the client computer system to the server computer system;
processing the list of the maintainable inventory items at the server computer system, the processing includes generating maintenance tasks relating to the list of the maintainable inventory items based upon a set of maintenance procedures; and
tracking the maintenance tasks at the server computer system.

10. The computer-method for managing a property of claim 9, the set of maintenance procedures is provided by a manufacture of one of the maintainable inventory items.

11. The computer-method for managing a property of claim 9, further comprising:
tracking an inventory of expendable items at the server computer system, the expendable items related to at least one of the of maintenance tasks.

12. The computer-method for managing a property of claim 9, further comprising:
tracking an inventory of reusable tools at the server computer system, the reusable tools used to perform at least one of the maintenance tasks.

13. The computer-method for managing a property of claim 11, further comprising:
when tracking the inventory of the expendable items, if a quantity of one of the expendable items falls below a predetermined amount, generating an order at the server computer system for replacement of the one of the expendable items.

14. The computer-method for managing a property of claim 13, further comprising automatically sending the order from the server computer system to a supplier computer system.

15. The computer-method for managing a property of claim 9, wherein the step of tracking includes generating at the server computer system a report of the maintenance tasks that are ready to be performed and sending the report to the client computer system.

16. The computer-method for managing a property of claim 9, further comprising transferring data files from the client computer system to the server computer system and storing data files for backup.

17. A system for managing a property, the system comprising:
a server computer system adapted to receive a list of maintainable items, the server computer system having a set of maintenance procedures and the server computer system adapted to generate a set of maintenance tasks from the list of the maintainable items and the set of the maintenance procedures;
a client computer system having a unique identity, the client computer system adapted to accept the list of the maintainable items and send the list of the maintainable items to the server computer system; and
a database interfaced to the server computer adapted to store the list of the maintainable items, the set of the maintenance procedures and the set of the maintenance tasks.

18. The system for managing a property of claim 19, wherein the database is further adapted to store a list of expendable items, the expendable items related to the set of the maintenance tasks and the server computer system is further adapted to associate the expendable items with the maintenance tasks.

19. The system for managing a property of claim 17, wherein the database is further adapted to store a list of tools, the tools used to complete at least one maintenance task in the set of the maintenance tasks; and the server computer further adapted to associate the tools with the maintenance tasks.

20. The system for managing a property of claim 17, wherein the server computer system is further adapted to track the set of the maintenance tasks and further adapted to generate a report on any maintenance tasks that are ready to perform from the list of maintenance tasks.

21. The system for managing a property of claim 20, wherein the server computer system is further adapted to accept a completion status from the client computer system and upon receiving the completion status, the server computer system is further adapted to deduct an amount of a related expendable item from the list of the expendable items.

22. The system for managing a property of claim 21, wherein the server computer system is further adapted to determine if, a remaining amount of the related expendable item is sufficient and, if the remaining amount of the related expendable item is not sufficient, the server computer system is further adapted to generate an order for a replacement of the related expendable item.

23. The system for managing a property of claim 22, wherein the server computer system is further adapted to send the order to a supplier of the related expendable item.

24. The system for managing a property of claim 21, wherein the server computer system is further adapted to accept backup data files from the client computer system and the server computer system is further adapted to store the backup data files for future retrieval by the client computer system.
